(19) United States
(12) Patent Application Publication
(10) Pub. No.: US 2009/0057622 A1
(43) Pub. Date: Mar. 5, 2009

(54) Simulant of Radiological Contamination

(75) Inventors: Charles W. Martin, Springfield, MO (US); Jeffry Golden, Creve Coeur, MO (US)

Correspondence Address: KANG INTELLECTUAL PROPERTY LAW, LLC, 214 ELM STREET, SUITE 106, WASHINGTON, MO, 63090, US

(73) Assignee: CLEAN EARTH TECHNOLOGIES, LLC, St. Louis, MO (US)

(21) Appl. No.: 11/848,616

(22) Filed: Aug. 31, 2007

(51) Int. Cl. H01B 1/00; G09B 23/00

(52) U.S. Cl. 252/501.1; 434/276

(57) ABSTRACT

A composition is formulated with generally regarded as safe (GRAS) ingredients for use as a non-radio-active simulant of radiological contamination such as fallout from a nuclear explosion, particulate from a radiological dispersal device, or contamination from operation of nuclear facilities. The compositions can be used for training exercises, testing, and research studies, and they can be applied safely to human skin. They include an ultraviolet (UV)-excited fluorescent ingredient that makes possible visible viewing of the simulants when illuminated by UV light. The chemical simulants have good fidelity with the physical properties of contamination, for example, adhesion, particle size, electrostatic charging, and response to decontamination technologies such as washing and vacuuming.

### STATEMENT REGARDING FEDERALLY SPONSORED RESEARCH

The development of the composition of this invention was supported, in part, by the Technical Support Working Group, an agency of the Federal Government, under contract N41756-05-C-4778. The Federal Government retains Government Purpose Rights, which include the right to use, modify, perform, display, release, or disclose technical data in whole or in part, in any manner or for any government purpose whatsoever, and to have or authorize others to do so in the performance of a Government Contract.

### CROSS-REFERENCE TO RELATED APPLICATIONS

None

### APPENDIX

Not Applicable.

### BACKGROUND OF THE INVENTION

1. Field of the Invention

The invention relates to a composition for use as a simulant of radiological contamination in training exercises, testing, and research studies that involve the detection and decontamination, especially for situations that involve direct human exposure.

2. Related Art

A non-radioactive simulant of radiological contamination, such as fallout from a nuclear explosion, particulate from a radiological dispersal device (RDD), or contamination from the operation of nuclear facilities, can provide emergency responders, military personnel, nuclear facility personnel, researchers, trainers, and training evaluators with means to learn, practice and evaluate methods and techniques for sampling and decontamination in training exercises, testing, and research studies. Such simulants can also be used for research studies to determine the transport and spread of contamination onto people, from person to person, and in the environment. Further, such simulants can be incorporated into training kits with simulants for other hazardous materials such as chemical and biological materials, and explosives.

The selection of a simulant for the development and evaluation of decontamination technologies generally has focused on providing a non-reacting particulate with a fluorescent characteristic that will emit visible light when excited by ultraviolet (UV) light illumination. Commercially available compositions, e.g., Glo Germ®, are available as powders and suspensions in oils and solution that can be used to show the effectiveness of washing and vacuuming decontamination methods. However, while such compositions may be relatively safe to handle, the issues of safety and simulant fidelity pertaining to safe human exposure when training for emergency response and decontamination after an event involving an RDD have not been addressed in the prior art. In training exercises where unprotected human exposure occurs, it is important that respirable particulate (per the ACGIH, see W. C. Hinds, 1999) be avoided, i.e., particulate with diameter smaller than about 10 μm, and that the simulant comprise Generally Regarded As Safe (GRAS) ingredients. Such ingredients are those listed in the International Cosmetic Ingredient Dictionary and Handbook (The Cosmetic, Toiletry, and Fragrance Association). Further, it is desirable that a simulant be environmentally safe for use in unrestricted areas.

High fidelity, non-toxic simulants are needed for emergency response and consequence management preparations in anticipation of future incidents involving radiological contamination. Desirable characteristics of simulants are particle size distribution, shape and asperities, adhesion as a function of relative humidity, tribo-electric and electrostatic properties, and persistence, as well as detection by visual observation of UV-excited fluorescence. Such visual detection should be practical and continue even as the particulate is wetted with decontaminating wash. Further, the fluorescent material should not be readily removed from the simulant during training exercises in such a way as to permanently stain or damage garments or valuable objects. Still further, the UV-excited fluorescence of the simulant should be distinguishable from the fluorescence of whiteners and brighteners that are commonly used in garment textiles, so that the presence of simulant on such textiles can be observed when illuminated by UV light.

The use of fluorescent materials in simulants for chemical toxants is well known in the prior art. Exemplary prior art are Seitzinger and Genovese (U.S. Pat. Nos. 6,566,138 and 7,129,094), Teta et al (International Publication No. WO 2004/040255 A2, U.S. Pat. No. 6,913,928), Molina (U.S. Pat. No. 4,858,465), and others. However, none of these have addressed the desirable set of properties of a simulant of radiological contamination.

The prior art does not provide such a simulant. Although previously available simulant powder can be sieved or screened to obtain particulate that has particle size larger than 10 μm and is “non-respirable” or to obtain a desired particle size distribution, such compositions are not specifically made of GRAS ingredients and do not have the characteristics for high fidelity to the anticipated characteristics of radiological contamination. In particular, particle adhesion depends on particle shape and asperities, on the electrical conductivity, dielectric constant, tribo-electric charging properties, interstitial water, and on the hydration of the particle surface as a function of relative humidity.

### SUMMARY OF THE INVENTION

The simulant composition comprises particulate of a partially hydrated silica gel with a small admixture of fluorescent food dye or other non-toxic fluorescent taggant. The ingredients of the simulant composition are listed in the International Cosmetic Ingredient Dictionary and Handbook, and they have established GRAS status. The simulant materials are non-toxic and non-irritating to human skin and mucous membranes. The simulants are environmentally safe and can be used for classroom and field operations training.

The principal ingredient, silica gel, is selected because it is an inorganic material that has persistence similar to particulate with bound or sorbed radiological contamination. With partial hydration, i.e., the admixture of some water, this material offers electrical properties that lead to adhesion characteristics that are comparable to anticipated radiological contamination and that also enable binding of a fluorescent dye so that the dye is not readily removed to stain or damage objects or skin to which the simulant is applied. Conductivity of the composition can be further adjusted by added salinity to the water.

The fluorescent taggant makes the simulant observable by visual inspection when illuminated by UV light. Ample UV light can be obtained from a hand held UV producing lamp. In this way, persons viewing the glowing taggant can identify the presence and location of the simulant. Transport and spreading of the simulant can be determined by repeated viewing. Because of the high fidelity characteristics (e.g., adhesion, persistence, and particle size distribution), the spread of simulant can mimic the spread of real contamination. Further, the visual detectability with UV illumination enables rapid evaluation, validation, development of tactics, techniques & procedures (TTPs), and training for sampling and the use of countermeasure technologies (for example decontamination and removal). By the use of the simulant composition of GRAS ingredients, these training, preparedness, and development activities can be performed safely, affordably, and with high fidelity to the outcomes of actual sampling, avoidance, decontamination, and handling of hazardous contamination.

The present invention is a GRAS simulant for radiological contamination, such as fallout from a nuclear explosion, particulate from a radiological dispersal device (RDD), or contamination from the operation of nuclear facilities, for use by emergency responders, military personnel, researchers, trainers, and training evaluators. The simulant can be assembled in a training kit that is portable and convenient to use in field exercises. The simulant of the invention can be applied to unprotected persons and animals, persons in personal protective equipment (PPE), equipment, and other objects without harm. The simulant can be observed by UV light excited fluorescence detection, such as by a trainee, trainer or training evaluator of a training exercise.

One use of the simulant may be in the development, conduct, and evaluation of training procedures and trainee proficiency evaluation related to countermeasures for radiological contaminants and in research studies of methods and techniques for the sampling, and decontamination of hazardous materials after an accidental or intentional release of radiological materials.

A different use for the simulant may be a method of using the simulant for training, research, and evaluation for sampling, decontamination, and the study of the transport of particulate contamination.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates the UV-excited fluorescent simulant as applied on a floor tile.

FIG. 1 illustrates the UV-excited fluorescent simulant as applied on a person.

FIG. 3 illustrates a plastic container with a powder dispensing top that may be used for dispensing the simulant.

### DETAILED DESCRIPTION OF THE INVENTION

The simulant composition comprises particulate of a partially hydrated silica gel with a small admixture of fluorescent food dye or other non-toxic fluorescent taggant. Silica gel provides a hydrophilic surface that can readily sorb water and water soluble salt. As a desiccant, commercially available silica gel has an effective surface area in the range of approximately 600 to 800 m²/g. Aqueous solutions are readily adsorbed. Typically, such a desiccant can sorb water up to 40% of the dehydrated gel weight. Consequently, the fluorescent material can be sorbed into the gel. Further, as described below, the silica gel provides a particulate matrix that has comparable properties to radiological contamination.

Contamination may arise as a consequence of a nuclear explosion, for example, the detonation of a fission or fusion device, as a release from a nuclear facility or during the transport of radioactive materials, or as the result of intentional radiological dispersal, for example, by aerosol spraying or detonation of an RDD. In the case of a nuclear explosion, immediate and long time fallout may result from radioactive bomb materials such as uranium or plutonium because of incomplete fission reactions, or by induced radioactivity in other bomb components or in environmental materials activated and dispersed by the explosion. Further, fallout may result from radioactive gases and volatile materials condensing onto or being absorbed into environmental materials, and generally comprising a large quantity of particulate. Other than the case of a nuclear explosion, the contamination is likely to comprise radioactive particulate as well as solid debris, liquids and gases.

Particulate contamination is well typified by the materials that may be encountered as a result of the use of an RDD. Several radionuclides have been identified as key candidates for RDDs. Nine of these are listed in Table I. Four of these are found in typical commercial radioactive sources. Some of these are waste or by-products of the nuclear power industry. Seven of these, except for Sr⁹⁰ and Po²¹⁰, are gamma-ray emitters. As gamma-rays are more penetrating, they may be more likely candidates as ingredients for a radiological weapon. In particular, Cs¹³⁷, Co⁶⁰, and Ir¹⁹² emit energetic photons. These three with Sr⁹⁰, a radionuclide that is commonly used in medical therapy, are used industrially in sources comprising up to 10,000 Curies. As shown in Table I, the typical forms for these radionuclides are either metallic or as salts, many of which are water soluble. It may be anticipated that the contamination from an RDD may comprise small metallic or low/insoluble salt particulate or bits of water-soluble salts. The water-soluble salts may be readily sorbed onto or into soil particulate, e.g., sand, silt, clay, or loam. For explosive dissemination the contamination may include particulate debris from the device. For dissemination by aerosol spraying, the contamination may include either carrier particulate or liquid, the radionuclide either being dissolved in the liquid, e.g., water, or being a suspension. As a result of the dispersal, common environmental particulate may become contaminated. Consequently, the contamination may comprise insoluble metallic particulate or environmental particulate with sorbed radio-active chemical compounds.

TABLE I
Key Radionuclides for RDDs

| | | Specific | |
|---|---|---|---|
| | Half-life | Activity | |
| Isotope | (years) | (Ci/g) | Typical form |
| Americium, Am²⁴¹ | 430 | 3.5 | Am oxide or AmBe powder |
| Californium Cf²⁵² | 2.6 | 540 | Cf oxide |
| Cesium Cs¹³⁷ | 30 | 88 | Cs chloride |
| Cobalt Co⁶⁰ | 5.3 | 1100 | Metallic Co or Ni—Co |
| | | | alloy |
| Iridium Ir¹⁹² | 0.2 (74 d) | 9200 | Metallic Ir |
| Plutonium Pu²³⁸ | 88 | 17 | Pu dioxide, ceramic-like |
| Polonium Po²¹⁰ | 0.4 (140 d) | 4500 | Metallic foil |
| Radium Ra²²⁶ | 1600 | 1.0 | Ra bromide or chloride |
| Strontium Sr⁹⁰ | 29 | 140 | Metallic Sr, Sr chloride, |
| | | | fluoride, or titanate |

Particle adhesion onto surfaces is the result of long range (e.g., van der Waals) and short range forces (chemical bonds), electrostatic forces, and the surface tension force of adsorbed liquid films. Consequently, the composition of the particle, its surface morphology, electrical properties, and wettability affect its adhesion to a surface as well as the condition of the surface, such as cleanliness and morphology, and environmental conditions, such as relative humidity. A good simulant should have comparable properties to the contamination particulate so that its adhesion will be comparable. By the above description of radiological contamination, it may be anticipated that such particulate will be electrically conducting, either as a metallic material, or as a chemical salt sorbed onto or into a soil particle. Further, clay or loam particles are hygroscopic. Relative humidity and contact with aqueous decontaminant wash will change the effective dielectric constant and also the electrical conductivity of the particles. These properties affect triboelectric charging of the particle and the rate of electrostatic discharge of a particle on a surface.

Silica gel has electrical properties of dielectric constant and electrical conductivity that depend on the amount of water sorbed by the gel. While dehydrated silica gel has low electrical conductivity, i.e. high resistivity ρ and is a good insulator, it is well known (Anderson and Parks) that the resistivity of the gel decreases approximately 1-2 orders of magnitude with the adsorption of 5-10 μmoles/m² of high purity water, e.g., from ρ˜3×10¹³ Ohm-cm to ρ˜5×10¹¹ Ohm-cm. High purity water can be de-ionized or distilled water, such water being produced by any or combinations of methods that include filtration, ion exchange, reverse osmosis, distillation, and other commercially available means. This water content corresponds to approximately 6-13% of the mass of the silica gel. For commercially available desiccant, this is about 15-33% of its water sorbing capacity. For water content greater than about 16 μmoles/m², the resistivity rapidly decreases (i.e., the conductivity increases) as a function of water content. When salinity is present in the water, the resistivity can be modeled by Archie's Law, namely, ρ≈ρ_{f}aφ^{-m}Sⁿ, where ρ_{f} is the resistivity of the salt solution (fluid), φ is the pore volume fraction, m is an empirical exponent, typically 1.3<m<2.5, S is the fractional water (fluid) content, and typically, n˜2. When S=0.1, m˜1.8, a=1 and φ=0.3, then, Archie's law yields ρ˜0.1 ρ_{f}. As the salinity of the water increases from 1 mg/liter (1 ppm) to 1 g/liter (1000 ppm), ρ varies from about 3×10³ Ohm-m to approximately 3 Ohm-m. Tap water, typically, may have about 40-100 ppm salinity. Thus, with the addition of approximately 10% by weight of water to the silica gel, the particles can be made sufficiently conductive to avoid the poor charging characteristics of highly insulating particulate. If such water content is attained with water having greater than 1 ppm of salinity, then conductivity that is typical of clay or loam soil particles is obtained.

The radiological simulant comprises a dust-free, 20-350 mesh, granulated inert silica gel particulate with a sorbed fluorescent taggant that is mixed with the gel particles as an aqueous solution comprising from 5% to about 25% of the weight of the silica gel. The minimum particle size (greater mesh number) is selected to avoid particles that are smaller than 10 μm dimension and are ‘respirable’ particles. In a preferred embodiment, the silica gel material is grade 12 silica gel desiccant that is available from Fisher Scientific (Fair Lawn, N.J.), catalog number S157-212. This material comprises a distribution of particle size that ranges from 28 to 200 mesh. The particle size distribution is typified by the data shown in Table II. Another suitable material is produced by W. R. Grace, Davison Division and is used for the manufacture of the Super Protek-Sorb™ packaged desiccant product line. These silica gel desiccants comply with Food and Drug Administration (FDA) Title 21 Code of Federal Regulation (CFR) for Direct Contact with Food and Pharmaceuticals. The dust-free silica gel desiccants are produced under 21 CFR Part 172, which regulates the manufacture of silica gel and also conforms to regulations declaring silica gel a GRAS under 21 CFR Part 182.

TABLE II
Particle Size Distribution of the Radiological Simulant

| | |
|---|---|
| DESICCANT | RADIOLOGICAL |
| SILICA GEL | SIMULANT |

| | % Weight | | % Weight |
|---|---|---|---|
| Mesh Size | Distribution | Micron Size | Distribution |
| 28 | 5.8 | 590 | 5.2 |
| 70 | 74.6 | 210 | 67.2 |
| 140 | 14.5 | 135 | 13.3 |
| 200 | 3.0 | 74 | 2.7 |
| ≧200 | 2.0 | 50 | 1.9 |
| 400 | 0.0 | 33 | 10.0 |

The fluorescent taggant may be any of several compounds listed in the International Cosmetic Ingredient Dictionary and Handbook. In visible light, the taggant should have a pale color so that the simulant is not readily seen and identified as simulant. For realism, a small amount of carbon particles of other colorant may be added to make the simulant appear as common environmental particles. There are many exemplary non-toxic fluorescent taggants, which include optical brighteners and whiteners used in cosmetics and in textiles, as described in Berthiaume et al (U.S. Pat. No. 5,830,446), Cohen (U.S. Pat. No. 6,313,181), and Charbit (US Patent Application Publication No. 2005/0137117), and prior art cited in these references. In a preferred embodiment, the taggant is a fluorescent food coloring dye. In a more preferred embodiment, the fluorescent taggant is D&C Yellow #8, which is a fluorescein disodium salt that has a characteristic pale yellow color in typical indoor lighting and outdoor daylight. It is GRAS and provides a yellow light emission when excited by UV light in the 350 to 400 nm wavelength range. This yellow emission is readily visible in contrast to the emission of fluorescent brighteners and whiteners that are commonly found in garments and textiles. The taggant may comprise up to 5% of the weight of the simulant composition. In a preferred embodiment, the taggant is a fluorescent food coloring dye that comprises 0.001 to 0.05% of the simulant composition. In a more preferred embodiment, the fluorescent food coloring dye comprises about 0.003 to 0.01% of the simulant composition.

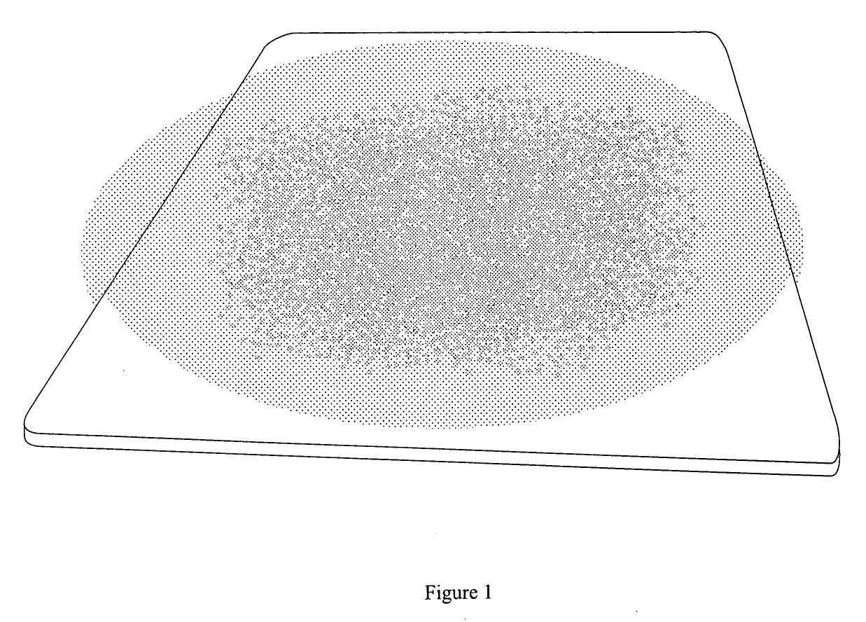

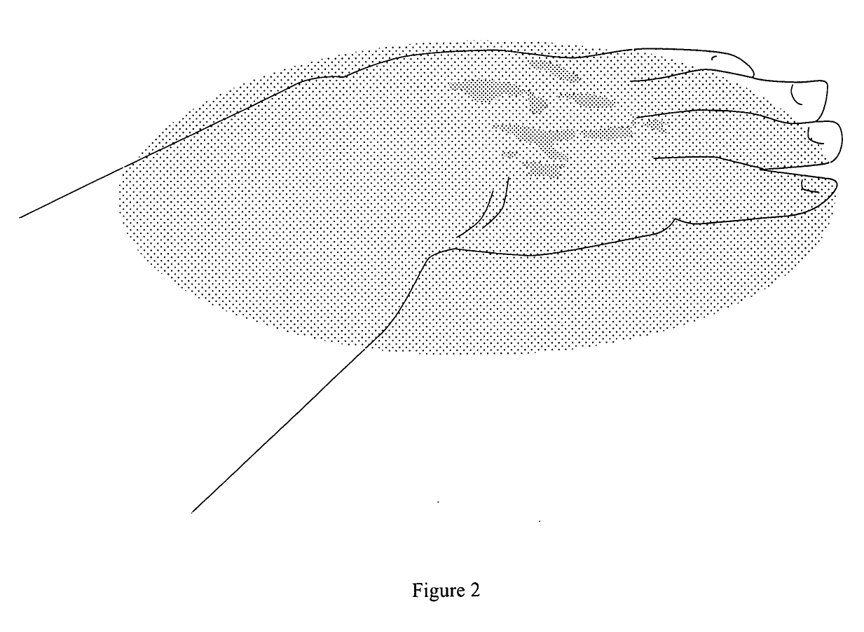

The performance of the radiological simulant on various materials has been tested in training exercises in which the simulant was applied to persons and objects and then removed by washing or vacuuming. Detection by visual observation of the UV-excited fluorescence was performed before and after the decontamination procedure. Detection prior to decontamination is easily done on the broad range of porous and non-porous materials to which the simulant was applied. It is found that the radiological simulant is not readily absorbed on porous surfaces. FIG. 1 shows the UV illuminated radiological simulant on floor tile. The fluorescent emission is easily seen in normal indoor lighting and in low-moderate outdoor daylight and at night when illuminated by a hand held UV lamp, such as a UV LED flashlight with a power of approximately 1 W and emission wavelength of approximately 390 nm.

The fluorescence of the simulant is also readily visible in the presence of interferants that might be encountered in the field, for example, skin lotions, perspiration, water, motor oil, dust/dirt, paints, whiteners, and reflective surfaces. The silica gel without an added fluor exhibits no significant background fluorescence with an excitation wavelength in the near UV or visible violet up to a wavelength of 450 nm.

Preparation of the compositions by mixing of the ingredients is straightforward. The order of addition is not important. However, in a preferred embodiment, a solution of fluorescent taggant and water is prepared and then added to the silica gel. The ingredients are then stirred to obtain a relatively homogeneous mixture of the fluor, water, and silica gel. In this way, a small concentration of fluorescent taggant in the simulant can be achieved easily.

The ingredients of the simulants are all environmentally safe, and they do not generate any hazardous waste byproducts.

An intended use of the simulant is a training aid in the areas of detection, contamination avoidance, contamination containment, decontamination, or contaminated material removal and handling. The simulant can be used under a broad range of ambient temperature (e.g., 0-50° C.) and weather conditions.

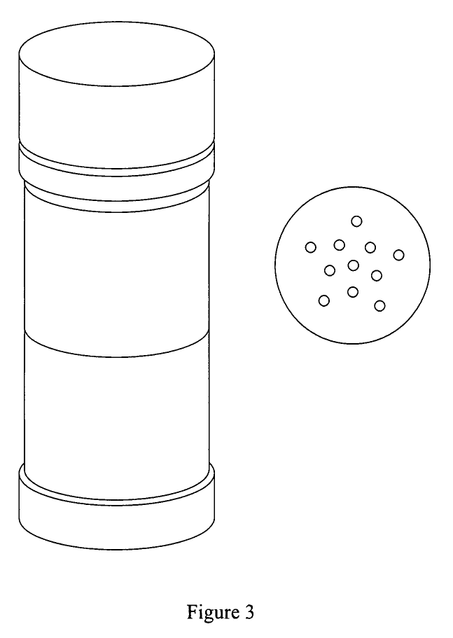

A useful means for dissemination of the simulant is a refillable, 8 oz. high density polyethylene (HDPE) plastic bottle with sifter (powder dispensing) cap and enclosure lid (FIG. 3). The radiological simulant is disseminated by removing the enclosure cap, orienting the bottle at a 45 degree angle and over the surface, and sifting the particulate onto the target surface with a gentle hand shaking motion. The simulant may be disseminated in thick, concentrated or thin, diluted zones depending on the desired training protocol in effect. The simulant may also be applied by a powder sprayer, for example, as an entrained particulate in an air jet.

Contamination may be encountered on surfaces as the result of a point release such as by a sprayer or an explosive dissemination or other radiological dispersion device, as fallout from an airborne cloud, or as wind-blown or contact transferred contamination. The simulant may be applied by similar means to those anticipated for an attack or other contamination event. The simulants may also be applied as a suspension in a solution by pouring, spraying, brushing, wiping, or smearing. In one embodiment, the solution may have a solvent that readily evaporates to leave the simulant particulate as a residue. Such an application can simulate the deposition of airborne contamination that is delivered to surfaces by atmospheric precipitation such as rain.

By any of such means, the simulant may be applied to surfaces in an amount that may be typical of anticipated contamination, e.g., at challenge levels of 0.1 to 10 g/m². FIG. 1 illustrates an amount of simulant applied to a floor tile. FIG. 2 illustrates an amount of simulant applied to a person.

The use of the simulant of radiological contamination may be made by the method comprising the following steps:

1. Designation of a scene or place and the objects and persons therein that are to be exposed to the simulant;

2. Application of the simulant as a powder by shaking (using a shaker shown in FIG. 3) or powder spraying, or as a suspension in a solution by aerosol spraying, pouring, brushing, sponging, wiping, or other appropriate means of dissemination so that the simulant contacts the surfaces of objects such as walls, persons, equipment, etc, or so that the simulant forms an aerosol cloud with particles or droplets that remain suspended for sufficient time for sampling, detection, or decontamination;

3. Detection of the contamination (represented by the simulant) by visual inspection of the fluorescence of the simulant when illuminated by UV light with wavelength in the 355-400 nm range and/or sampling of the contamination (represented by the simulant) for subsequent analysis or detection;

4. Optionally, the conduct of decontamination means, which may include physical removal of contamination (represented by the simulant) or contaminated articles, for example by washing or vacuuming;

5. Optionally, the evaluation or scoring or the effectiveness of the training, sampling, decontamination, research, or success of the activity using the simulant for another purpose; and

6. The cleaning up of the scene, place, objects, persons, etc by use of appropriate means, for example, water, soap and water, sweeping, or vacuuming. It should be obvious to those practiced in the art that the above descriptions are exemplary and not meant to be limiting as the method for use, the specific compositions, and the choice of fluorescent taggant may have many variations.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A simulant of radiological contamination comprising:
partially hydrated silica gel particles of non-respirable size;
a generally regarded as safe (GRAS) fluorescent compound; and
water with salinity in a selected amount to obtain a desired electrical conductivity of the composition.

2. The simulant of radiological contamination of claim 1, wherein said simulant contains between more than 0% and 20% distilled or de-ionized water.

3. The simulant of radiological contamination of claim 1, wherein said fluorescent taggant is D&C Yellow #8.

4. The simulant of radiological contamination of claim 1, wherein said fluorescent taggant comprises between 0.01% and 0.1% of the simulant.

5. The simulant of radiological contamination of claim 1, where said water has salinity in the range of 10 to 1000 ppm to obtain electrical conductivity of the composition that is comparable to environmental particulate.

6. The use of the simulant of radiological contamination of claim 5, wherein the simulant is applied to the skin of a person or animal.

7. The use of the simulant composition of radiological contamination comprising partially hydrated silica gel particles of non-respirable size, and a generally regarded as safe (GRAS) fluorescent compound, and water with salinity in a selected amount to obtain a desired electrical conductivity of the composition for one or more purposes selected from the group consisting of: training in the use of sampling devices and methods, training in the decontamination of persons, equipment, or places that are contaminated with radiological materials, conducting research, evaluating training or decontamination effectiveness, and the study of the transport and spread of radiological contamination.

8. A method of training in the use of radiological contamination sampling equipment, sampling methods, or decontamination procedures and technologies, or conducting research in the transport phenomena of radiological contamination, and research and development of countermeasures for radiological contamination, the method comprising:
using a simulant composition for radiological contamination comprising partially hydrated silica gel particles of non-respirable size, and a generally regarded as safe (GRAS) fluorescent compound, and water with salinity in a selected amount to obtain a desired electrical conductivity; and
applying said simulant on and contacting said simulant to one or more of the group comprising: inanimate objects, plants, persons, and animals;
observing and/or detecting the simulant on the surface of an object, person, plant, or animal, by one of visual observation and by visual observation of the fluorescence of the simulant

9. A method of training according to claim 8, further comprising:
performing sampling, decontamination, research in the transport phenomena of radiological contamination, or research and development of countermeasures for radiological contamination.

10. A method of training according to claim 9, further comprising:
performing sampling, analysis, or evaluation of the success of the training or research or development.
